(19) United States
(12) Patent Application Publication
(10) Pub. No.: US 2005/0047635 A1
(43) Pub. Date: Mar. 3, 2005

(54) Method, apparatus and program for image processing

(75) Inventors: Akira Oosawa, Kanagawa-ken (JP); Yasuo Iwabuchi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/924,870

(22) Filed: Aug. 25, 2004

(30) Foreign Application Priority Data
Aug. 27, 2003 (JP) 302857/2003

(51) Int. Cl. G06K 9/00

(52) U.S. Cl. 382/130

(57) ABSTRACT

A method, apparatus and program for image processing capable of obtaining useful information for identifying the abnormal pulmonary ventilation region from the projected chest radiation images. An air-inhaled image obtained when air is inhaled into lungs and a gas-inhaled image obtained when non-radioactive xenon gas is inhaled into the lungs are aligned by the aligning means, and a subtraction image representing the difference between the two images aligned by the aligning means is created by the subtraction image creating means. The information representing the abnormal pulmonary ventilation region is indicated in the subtraction image in which the anatomical noise arising from the bony part and the like, and artifacts arising from the positional displacement due to the change in the bodily posture of the subject are suppressed.

### BACKGROUND OF THE INVENTION

1. Field of the invention

The present invention relates to a method, apparatus and program for image processing. More specifically, the present invention relates to a method, apparatus and program for image processing for projected chest radiation images appropriate for identifying abnormal pulmonary ventilation regions.

2. Description of the Related Art

In the field of medicine, the diagnosis for identifying abnormal pulmonary ventilation regions (where gases such as air are not ventilated) is practiced by examining pulmonary ventilatory functions. One of the diagnostic methods described above is proposed as described, for example, in the article by Y. Yasuhara, J. Ikezoe, and K. Shimizu, entitled “Mapping of Pulmonary Ventilation with Non-radioactive Xenon-enhanced CT”, Medical Imaging Technology, 18, 2000, 187, in which the diagnosis is made through chest CT images obtained with non-radioactive xenon gas as the contrast medium.

In the diagnostic method described above, non-radioactive xenon gas is used as the contrast medium for obtaining pulmonary X-ray images as it has a higher absorption rate of X-ray than air, and also the absorption rate is proportional to the gas concentration, and a pulmonary CT image obtained when non-radioactive xenon gas is inhaled into lungs and a pulmonary CT image obtained when air is inhaled into the lungs are compared, and the region in the lung fields where no difference in density is observed on the two pulmonary CT images is identified as the abnormal pulmonary ventilation region.

The diagnostic method described above requires CT imaging equipment which is very expensive and difficult to handle.

On the other hand, the equipment for obtaining an ordinary projected X-ray image (a projected image of a subject obtained by recording X-ray transmitted through the subject) is less expensive and comparatively easy to handle.

Thus, if ordinary projected X-ray images could be used instead of CT images in the diagnostic method described above, and the abnormal pulmonary ventilation region is identified by comparing a projected pulmonary X-ray image obtained when non-radioactive xenon gas is inhaled into lungs and a projected X-ray image obtained when air is inhaled into the lungs, a less expensive and simpler diagnosis may be realized for identifying the abnormal pulmonary ventilation region.

Here, the problem standing in the way is the existence of so called anatomical noise contained in the projected X-ray image. The anatomical noise is the tissue image of the subject contained in the projected X-ray image which is obstructive to the image diagnosis. The projected X-ray image contains the anatomical noise (which consists mainly of the bony part image of the subject when identifying the abnormal pulmonary ventilation region) in larger amount than the CT image as it is by nature an image in which all the information contained in the thickness direction of the subject is projected, so that it is difficult to identify the abnormal pulmonary ventilation region by the simple comparison of the projected X-ray images.

In this connection, a diagnostic method for identifying the abnormal pulmonary ventilation region may be conceived, in which the density of corresponding regions of two projected X-ray images are compared to extract the regions where the difference in density is observed (pulmonary regions having normal ventilatory functions), and the abnormal pulmonary ventilation region is identified based on the distribution of the extracted regions. But, when imaging the projected X-ray images of the subject to be compared, the bodily posture of the subject is readily changed due to the imaging mode, and the positional displacement may occur between the two images to be compared, so that the method described above may not provide useful diagnostic information for identifying the abnormal pulmonary ventilation region.

### SUMMARY OF THE INVENTION

In recognition of the circumstance described above, it is an object of the present invention to provide a method, apparatus and program for image processing capable of obtaining useful information for identifying the abnormal pulmonary ventilation region from the projected chest radiation images.

The image processing method of the present invention comprises the steps of: aligning a first image obtained when air is inhaled into lungs and a second image obtained when a gas having a different absorption rate of radiation from that of the air is inhaled into the lungs, the first and second images being projected radiation images of the same chest obtained through radiation imaging; obtaining differential information representing the difference between the two images by comparing the two images aligned with each other; and outputting the differential information obtained.

Here, the term “projected radiation image” as used herein means a projected image of a subject obtained by recording the radiation transmitted through the subject. One of the typical projected radiation images is a digital X-ray image of a subject digitally obtained by detecting the X-ray transmitted through the subject using a detecting medium such as a storage phosphor sheet, flat panel detector and the like.

The term “aligning” as used herein means moving or transforming at least one of the images described above such that the position of anatomic hallmarks of the subject in the two images to be compared substantially corresponds (overlaps) with each other, in which affine transformations (rotation, translation) and warping as described, for example, in U.S. Patent Laid-Open No. 20010002934 and the like may be used.

The term “differential information” as used herein means the information indicating the difference in image signals between the two sets of image data representing the two images described above respectively, and includes at least the information on the lung fields of the chest.

In the image processing method according to the present invention, the two images described above may be plainly imaged chest radiation images or energy-subtracted soft part images of the chest with the bony part image of the chest eliminated, each obtained by performing the inter-image operation between the two radiation images obtained by recording radiations having different energy distributions with each other transmitted through the chest.

The term “energy” as used herein means wavelength (or frequency)-related energy of radiation, and not simply indicating the general intensity of the radiation.

The term “plainly imaged chest radiation image” as used herein means an image obtained by recording the radiation transmitted through the chest without any further processing, and is distinguished from the energy-subtracted soft part image described above.

The term “energy-subtracted soft part image” as used herein means an image representing the soft part of the subject with the bony part eliminated, which may be generated by making use of the fact that the bony part and soft part have different absorption spectra of radiation. It is created by first obtaining two radiation images having difference in contrast between the bony part and soft part by recording radiations having different energy distributions with each other transmitted through the chest, then performing the inter-image operation, primarily the subtractive operation between the two images obtained.

If the two images described above are the energy-subtracted soft part images, the radiations having different energy distributions with each other may be a monochromatic radiation having the energy corresponding to the pre-K-edge region of the gas and a monochromatic radiation having the energy corresponding to the post-K-edge region of the gas described above.

The term “monochromatic radiation” as used herein means a radiation having a much narrower energy distribution width (spectrum) compared with the radiation used for the general radiation imaging, with the width of, for example, around 0.5 KeV.

The monochromatic radiation may be obtained by dispersing the radiation emitted from an ordinary radiation source through a spectroscope or the like.

The term “K absorption edge” as used herein means one of the absorption edges (wavelength position where the absorption rate of radiation starts to increase locally in the absorption spectrum) of an individual element having the highest energy among them and located close to the energy region of the radiation used for radiation imaging. The “K absorption edge” is also referred to as “K-shell absorption edge”.

The term “pre-K-edge region” as used herein means a wavelength region on the side of the longer wavelength of the K absorption edge where the absorption rate of radiation drops locally, and the term “post-K-edge region” means a wavelength region on the side of the shorter wavelength of the K absorption edge where the absorption rate of radiation increases locally.

Generally, the monochromatic radiation has energy distributions with a certain distribution width and broadened skirts, though it has high monochromaticity, and it is difficult to contain all the energy components of the monochromatic radiation within a specific wavelength region. But, in general, it is assumed that if 80% or more energy components are contained in the specific wavelength region, it will be able to provide sufficient advantageous effects as the monochromatic radiation. Therefore, “the monochromatic radiation having the energy corresponding to the pre-K-edge region or post-K-edge region” may be a monochromatic radiation containing 80% or more of its energy components in the wavelength region of the pre-K-edge or post-K-edge region.

Further, the differential information described above may be a subtraction image representing the difference between the two images described above, or it may be the information that indicates a region satisfying a predefined criterion among the regions where the difference is observed between the two images described above.

The subtraction image described above maybe a subtraction image obtained by performing the subtractive operation between the two images described above without making any adjustment to the density or by performing the subtractive operation after shifting the density of at least one of the images described above to make the average density of the lung fields substantially the same level in the two images.

The abnormal pulmonary ventilation region is a region where virtually no ventilation takes place, so that it has a specific quality that it always appears in the radiation images at the same density level regardless of whether a contrast medium is contained in the lungs or not (provided that other imaging conditions are the same). Thus, in the subtraction image described above, the abnormal pulmonary ventilation region appears at a different density level from that of a normal pulmonary ventilation region within the lung fields. This quality may be used for identifying abnormal pulmonary ventilation regions.

Satisfying the predefined criterion described above may be defined, for example, as either or both of the difference between the two images described above, and the size of the region having the difference described above are greater than or equal to a predetermined threshold.

As for the gas described above, for example, non-radioactive xenon gas may be used.

An image processing apparatus of the present invention comprises: an aligning means for aligning a first image obtained when air is inhaled into lungs and a second image obtained when a gas having a different absorption rate of radiation from that of the air is inhaled into the lungs, the first and second images being projected radiation images of the same chest obtained through radiation imaging; a differential information obtaining means for obtaining differential information representing the difference between the two images by comparing the two images aligned with each other by the aligning means; and an outputting means for outputting the differential information obtained by the differential information obtaining means.

Here, as for the outputting means, for example, a displaying means for displaying the differential information on a screen, such as a CRT screen or liquid crystal panel; a hard-copying means for hard-copying the differential information on paper or film; and a transmitting means for transmitting the differential information as image data to a memory or other devices connected to the image processing apparatus of the present invention are possible.

The two images described above are, of course, not limited to those obtained with the intention of applying the image processing method of the present invention. As such, at least one of the images described above may be an image obtained in the past for other purposes.

Further, X-ray may be included in the radiation described above, but it is not limited to X-ray.

The program of the present invention is a program for causing a computer to act as an aligning means for aligning a first image obtained when air is inhaled into lungs and a second image obtained when a gas having a different absorption rate of radiation from that of the air is inhaled into the lungs, the first and second images being projected radiation images of the same chest obtained through radiation imaging; a differential information obtaining means for obtaining differential information representing the difference between the two images by comparing the two images aligned with each other by the aligning means; and an outputting means for outputting the differential information obtained by the differential information obtaining means.

The program described above may be recorded and supplied on a computer readable recording medium, or it may be stored in a server accessible by the computer and supplied through downloading.

The image processing method and apparatus according to the present invention, a first image obtained when air is inhaled into lungs and a second image obtained when a gas having a different absorption rate of radiation from that of the air is inhaled into the lungs are aligned, the first and second images being projected radiation images of the same chest region obtained through radiation imaging, then differential information representing the difference between the two images is obtained by comparing the two images aligned with each other, and the differential information obtained is outputted, so that clear differential information may be obtained from the two images with reduced negative effects of the anatomical noise often contained in projected radiation images in large amount and of the positional displacement of the subject due to the change in the bodily posture of the subject, which often become the problem in identifying the abnormal pulmonary ventilation region using the projected radiation images, thereby useful information for identifying the abnormal pulmonary ventilation region from the projected chest radiation images may be obtained. This allows a less expensive and simpler diagnosis for identifying the abnormal pulmonary ventilation region.

In the image processing method of the present invention, if the two images described above are plainly imaged chest radiation images, useful information for identifying the abnormal pulmonary ventilation region may be obtained in the least expensive and simplest method as the radiation images obtainable by the most common radiation imaging are used.

In the image processing method of the present invention, if the two images described above are energy-subtracted soft part images of the chest with the bony part image of the chest eliminated, each obtained by performing the inter-image operation between the two radiation images obtained by recording radiations having different energy distributions with each other transmitted through the chest, the comparison maybe made between the two images with the bony part image constituting the anatomical noise eliminated in advance, thereby the differential information with less amount of anatomical noise may be obtained.

Here, if the two radiations having different energy distributions are a monochromatic radiation having the energy corresponding to the pre-K-edge region of the gas and a monochromatic radiation having the energy corresponding to the post-K-edge region of the gas respectively, the difference in the density of the soft part with the gas inhaled therein becomes greater on the two images obtained, so that the energy-subtracted soft part image obtained from the two images becomes a high-contrast image in which the soft part with the gas inhaled is emphasized, that is, the lung fields are primarily emphasized, thereby further clarified differential information (subtraction image) may be obtained.

### BRIEF DESCRIPTION OF THE DRAWINGS

FIG. 1 is a drawing illustrating the image processing apparatus according to a first embodiment of the present invention.

FIG. 2 is a processing flow diagram of the image processing apparatus according to a first embodiment of the present invention.

FIG. 3A is a drawing schematically illustrating an air-inhaled image P1.

FIG. 3B is a drawing schematically illustrating a gas-inhaled image P2.

FIG. 4 is a drawing illustrating a subtraction image Su1.

FIG. 5 is a drawing illustrating the image processing apparatus according to a second embodiment of the present invention.

FIG. 6 is a processing flow diagram of the image processing apparatus according to a second embodiment of the present invention.

FIG. 7A is a drawing schematically illustrating an air-inhaled energy-subtracted image P3.

FIG. 7B is a drawing schematically illustrating a gas-inhaled energy-subtracted image P4.

FIG. 8 is a drawing illustrating a subtraction image Su2.

FIG. 9 is a drawing illustrating the relationship between the amount of X-ray absorbed by the bony part and soft part with xenon gas inhaled and the energy of the X-ray.

FIG. 10A is a drawing illustrating an image contrast obtained by X-ray having certain energy distributions.

FIG. 10B is a drawing illustrating an image contrast which is different from that shown in FIG. 10A obtained by another X-ray having different energy distributions from those of the X-ray in FIG. 10A.

### DESCRIPTION OF THE PREFERRED EMBODIMENTS

Hereinafter, preferred embodiments of the present invention will be described with reference to the accompanying drawings.

An image processing apparatus according to a first embodiment of the present invention will be described.

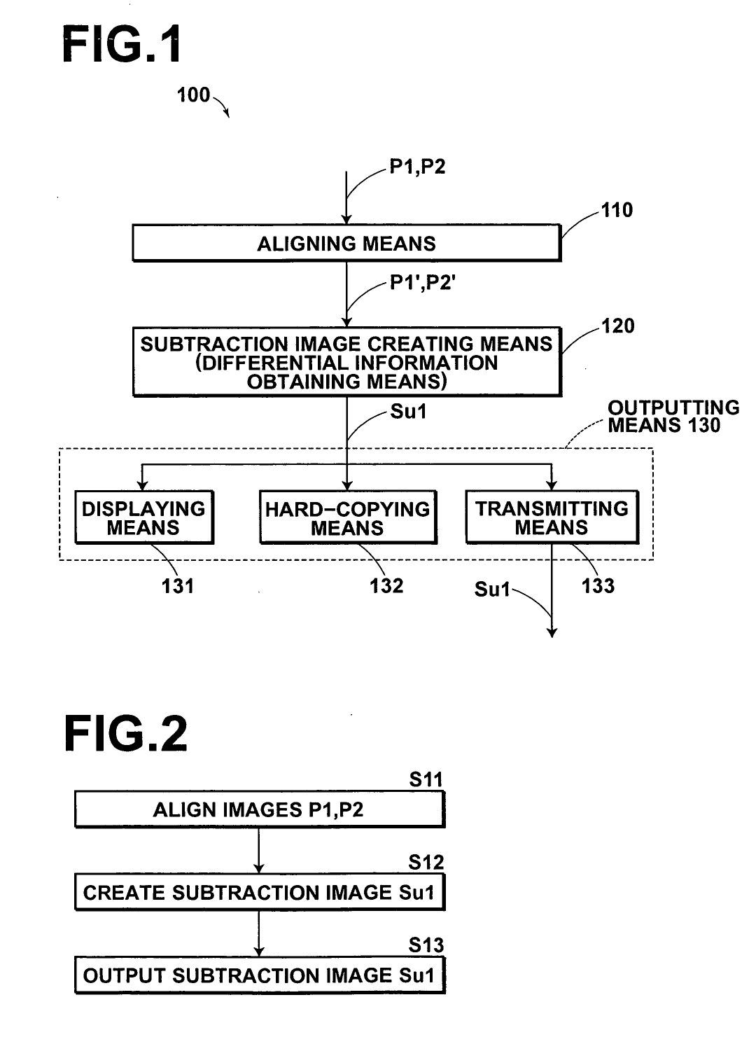

FIG. 1 shows an image processing apparatus 100 according to an embodiment of the present invention. The image processing apparatus 100 comprises: an aligning means 110 for aligning an air-inhaled image P1 obtained when air is inhaled into lungs and a gas-inhaled image P2 obtained when non-radioactive xenon gas is inhaled into the lungs, the first and second images being plainly imaged chest radiation images of the same chest; a subtraction image creating means 120 acting as a differential information obtaining means for obtaining a subtraction image Su1 representing the difference between the two images by comparing the two images aligned by the aligning means 110; and an outputting means 130 for outputting the subtraction image Su1 obtained by the subtraction image creating means 120.

The outputting means 130 comprises: a displaying means 131 for displaying the subtraction image Su1 on a screen, such as CRT and the like; a hard-copying means 132 for hard-copying the subtraction image Su1 on paper or film; and a transmitting means 133 for transmitting the subtraction image Su1 as image data to a memory or other devices (not shown) connected to the image processing apparatus 100.

Here, the plainly imaged chest radiation image is an image obtained by recording the radiation transmitted through the chest without any further processing.

In this embodiment, the radiation imaging and radiation images are assumed to be X-ray imaging and X-ray images. In addition, it is assumed that the region in the X-ray image that has received a larger dose of radiation transmitted through a subject appears darkly and the region that has received a smaller dose of radiation appears brightly, and the image is a high density and high signal level image.

Hereinafter, the operation of the image processing apparatus 100 will be described. FIG. 2 shows the processing flow of the image processing apparatus 100 according to the first embodiment of the present invention.

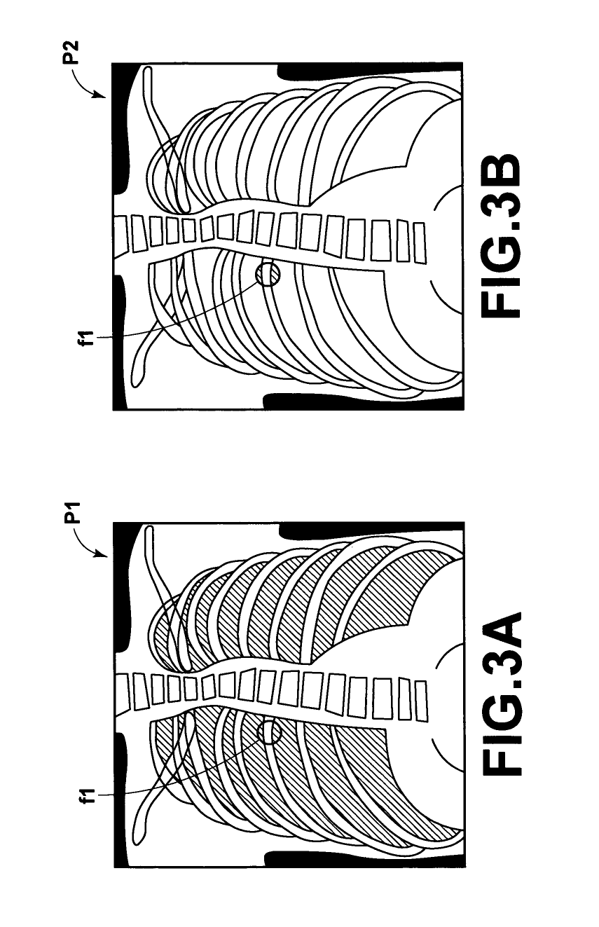

Firstly, an air-inhaled image P1 and a gas-inhaled image P2 shown in FIGS. 3A and 3B respectively are inputted to the image processing apparatus 100, the images P1 and P2 being the images of the same chest including lungs having an abnormal pulmonary ventilation region f1.

The air-inhaled image P1 is obtained through X-ray imaging of the chest with air inhaled into the lungs. The lung fields of the image P1 become darker, and other tissue region becomes comparatively brighter as the amount of X-ray absorbed by the air in the lungs is small, and the outside region of the subject becomes pitch-black in the image P1. Meanwhile, the gas-inhaled image P2 is obtained through X-ray imaging of the chest with non-radioactive xenon gas having a greater absorption rate of X-ray than that of the air inhaled into the lungs, in which the amount of X-ray absorbed by the gas in the lungs is greater than that absorbed by the air, so that the lung fields in the image become brighter than those of the air-inhaled image, and other regions have substantially the same density levels as those of the air-inhaled image.

When the air-inhaled image P1 and gas-inhaled image P2 described above are inputted to the image processing apparatus 100, the aligning means 110 aligns the two images by moving and transforming at least one of the images such that the anatomic hallmarks in the subject region of the two images are substantially aligned (step S11). For this purpose, the affine transformations (rotation, translation) and warping as described, for example, in U.S. Patent Laid-Open No. 20010002934 and the like may be used. The images P1, P2 are converted to images P1′, P2′ respectively through this aligning operation.

After images P1, P2 are aligned with each other and converted to images P1′, P2′ by the aligning means 110, the subtraction image creating means 120 creates a subtraction image (subtraction image) Su1 representing the difference in density between the two images by performing the inter-image operation between the images P1′ and P2′ (step S12). As for the inter-image operation, the subtractive operation that performs subtractive operations between corresponding pixels of the images P1′ and P2′ may be used. In addition, weighted subtractive operation, in which a weight is allocated to the difference obtained through the subtractive operation in accordance with the amount of difference and the position in the image and the like, may also be used. In this embodiment, the subtraction image Su1 is assumed to have been obtained through the subtractive operation in which the image P2′ has been subtracted from the image P1′.

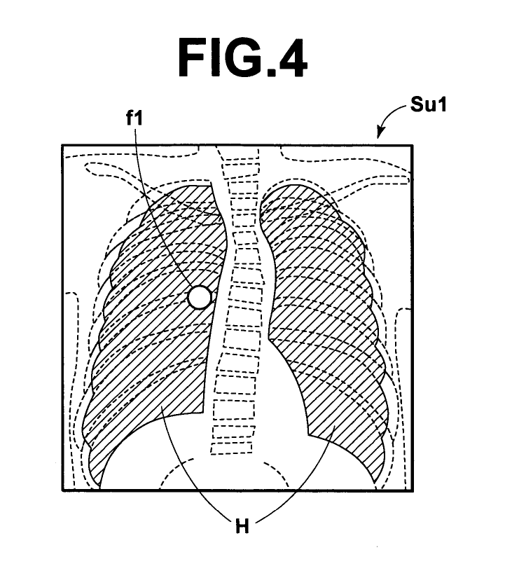

FIG. 4 shows the subtraction image Su1. In the subtraction image Su1 created in the manner described above, the anatomical noise, such as the bony part and the like which are obstructive in identifying the abnormal pulmonary ventilation region is eliminated, the artifact arising from the positional displacement due to the change in the bodily posture is suppressed, and the difference between the images P1′ and P2′ is emphasized. The abnormal pulmonary ventilation region is a region where virtually no ventilation takes place, so that it has a specific quality that it always appears in the X-ray images at the same density level regardless of whether a contrast medium (non-radioactive xenon gas) is inhaled into the lungs or not. Accordingly, in the subtraction image Su1, the abnormal pulmonary ventilation region f1 appears at a low density level (substantially in pure white) in the lung fields H indicated in the intermediate density level. This quality may be used for identifying the abnormal pulmonary ventilation region.

After the subtraction image Su1 is created by the subtraction image creating means 120, the displaying means 131 displays the subtraction image Su1 on a CRT screen or the like, the hard-copying means 132 produces the hard copy of the subtraction image Su1 on paper or film, or the transmitting means 133 transmits the subtraction image Su1 as image data to a database or other devices (not shown) connected to the image processing apparatus 100 (step S13).

Thereafter, the image examiner examines the subtraction image Su1 displayed on the screen, or recorded on paper or film to identify the abnormal pulmonary ventilation region based on the quality of the abnormal pulmonary region described above. Further, the subtraction image Su1 stored in a database or the like may be read out for diagnosis when needed.

According to the image processing apparatus 100 of the present invention described above, a first image obtained when air is inhaled into lungs and a second image obtained when a gas having a different absorption rate of X-ray from that of the air is inhaled into the lungs are aligned, the first and second images being projected radiation images of the same chest obtained through radiation imaging, then differential information representing the difference between the two images is obtained by comparing the two images aligned with each other, and the differential information obtained is outputted, so that clear differential information may be obtained from the two images with reduced negative effects of the anatomical noise often contained in projected radiation images in large amount and of the positional displacement of the subject due to the change in the bodily posture of the subject, which often become the problem in identifying the abnormal pulmonary ventilation region using projected radiation images, thereby useful information for identifying the abnormal pulmonary ventilation region from the projected chest radiation images may be obtained. This allows a less expensive and simpler diagnosis for identifying the abnormal pulmonary ventilation region.

Hereinafter, an image processing apparatus according to a second embodiment of the present invention will be described.

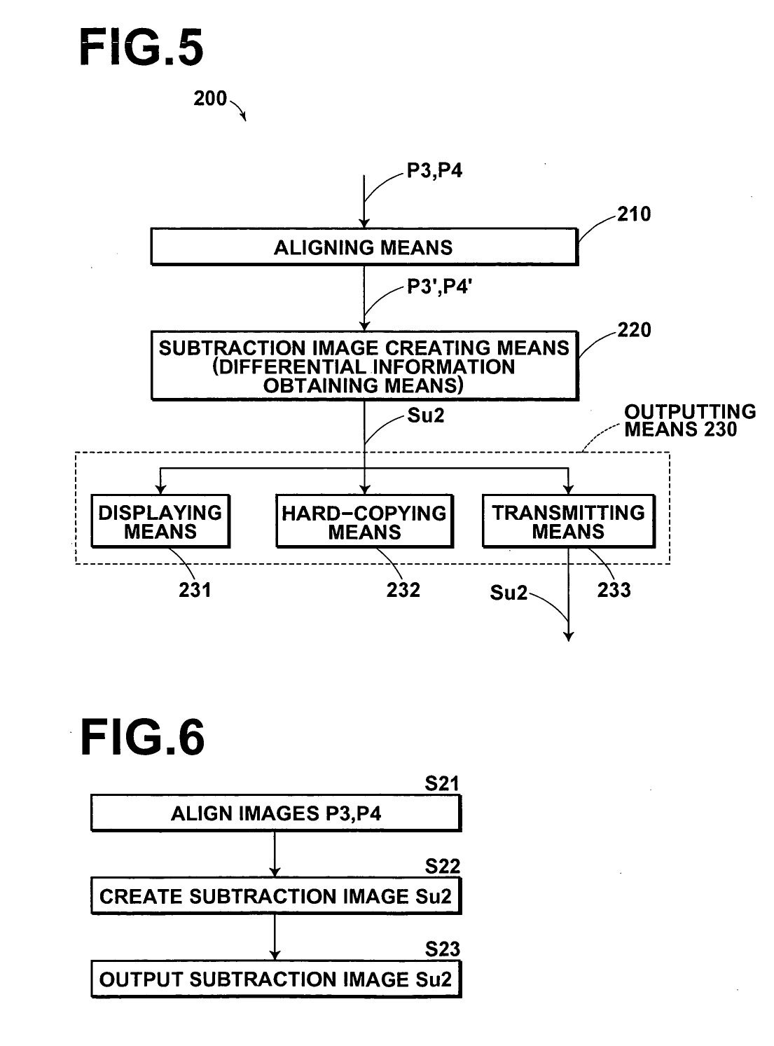

FIG. 5 shows an image processing apparatus 200 according to an embodiment of the present invention. The image processing apparatus 200 comprises: an aligning means 210 for aligning an air-inhaled energy-subtracted image P3 obtained when air is inhaled into lungs, and a gas-inhaled energy-subtracted image P4 obtained when non-radioactive xenon gas is inhaled into the lungs, the first and second images being energy-subtracted soft part images of a chest with the bony part of the chest eliminated, each obtained by performing the inter-image operation between two radiation images obtained by recording radiations having different energy distributions with each other transmitted through the chest; a subtraction image creating means 220 acting as a differential information obtaining means for obtaining a subtraction image Su2 representing the difference between the two images by comparing the two images aligned by the aligning means 210; and an outputting means 230 for outputting the subtraction image Su2 obtained by the subtraction image creating means 220.

The outputting means 230 comprises: a displaying means 231 for displaying the subtraction image Su2 on a screen, such as CRT and the like; a hard-copying means 232 for hard-copying the subtraction image Su1 on paper or film; and a transmitting means 233 for transmitting the subtraction image Su2 as image data to a memory or other devices (not shown) connected to the image processing apparatus 200.

Here, the energy-subtracted soft part image is a soft part image with the bony part eliminated, which is obtainable based on the fact that the bony part and soft part forming the subject differ from each other in X-ray absorption spectrum, and created by obtaining two images, each having different contrast between the soft part and bony part, and the performing inter-image operation, primarily the subtractive operation between the two images obtained.

In this embodiment, the radiation imaging and radiation images are assumed to be X-ray imaging and X-ray images. In addition, it is assumed that the region in the X-ray image that has received a larger amount of radiation transmitted through a subject appears darkly and the region that has received a smaller amount of radiation appears brightly, and the image is a high density and high signal level image.

Hereinafter, the operation of the image processing apparatus 200 will be described. FIG. 6 shows the processing flow of the image processing apparatus 200 according to the second embodiment of the present invention.

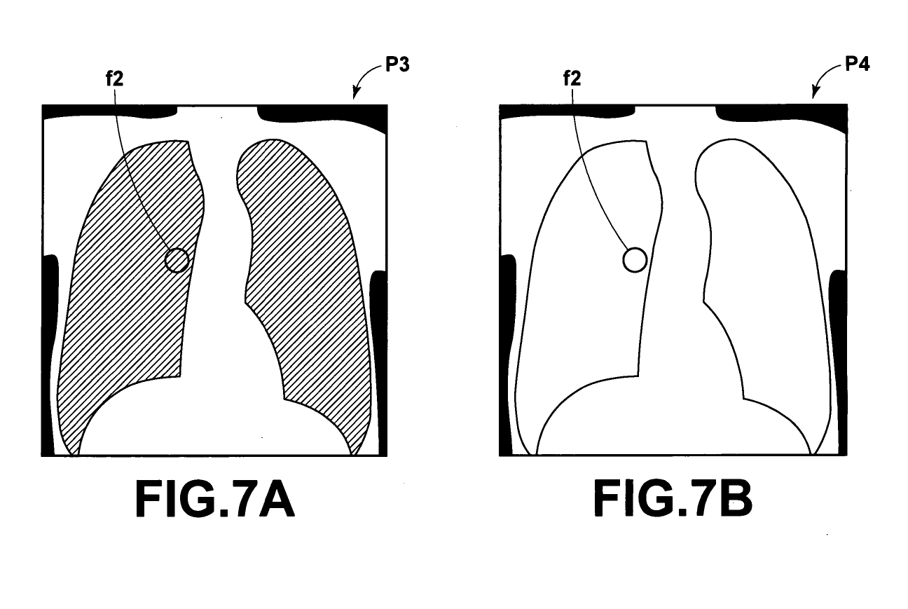

Firstly, an air-inhaled energy-subtracted image P3 and a gas-inhaled energy-subtracted image P4 shown in FIGS. 7A and 7B respectively are inputted to the image processing apparatus 200, the images P3 and P4 being energy-subtracted soft part images of the same chest including lungs having an abnormal pulmonary ventilation region f2.

The air-inhaled energy-subtracted image P3 is an energy-subtracted soft part image with the bony part eliminated, which is created by the steps of: obtaining an image P3a with the bony part having a low density level by recording X-ray having energy distributions that cause the bony part to have a higher absorption rate of X-ray transmitted through a chest with air inhaled in the lungs; obtaining an image P3b with the soft part having a low density level by recording X-ray having energy distributions that cause the soft part to have a higher absorption rate of X-ray transmitted through the chest with the air inhaled in the lungs; and making adjustments to the two images, P3a and P3b, such that the bony part of the two images has the same density level, and performing the subtractive operation in which the image P3b is subtracted from the image P3a to obtain the image P3. The lung fields of the image P3 become comparatively darker and other tissue region becomes comparatively brighter as the amount of X-ray absorbed by the air in the lungs is small, and the outside region of the subject becomes pitch-black in the image P3. Meanwhile, the gas-inhaled energy-subtracted image P4 is an energy-subtracted soft part image with the bony part eliminated, which is created by the steps of: obtaining an image P4a with the bony part having a low density level by recording X-ray having energy distributions that cause the bony part to have a higher absorption rate of X-ray transmitted through a chest with non-radioactive xenon gas having a higher absorption rate of X-ray than that of the air inhaled in the lungs; obtaining an image P4b with the soft part having a low density level by recording an X-ray having energy distributions that cause the soft part to have a higher absorption rate of X-ray transmitted through the chest with the non-radioactive xenon gas inhaled in the lungs; and making adjustments to the two images, P4a and P4b, such that the bony part of the two images has the same density level, and performing the subtractive operation in which the image P4b is subtracted from the image P4a to obtain the image P4. The lung fields of the image P4 become brighter than those of the air-inhaled energy-subtracted image, and other regions have substantially the same density levels as those of the air-inhaled image since the amount of X-ray absorbed by the gas is greater than that absorbed by the air in the lungs.

When the air-inhaled energy-subtracted image P3 and gas-inhaled energy-subtracted image P4 described above are inputted to the image processing apparatus 200, the aligning means 210 aligns the two images by moving and transforming at least one of the images such that the anatomic hallmarks in the subject region of the two images are substantially aligned (step S21). For this purpose, the affine transformations (rotation, translation) and warping as described, for example, in U.S. Patent Laid-Open No. 20010002934 and the like may be used. The images P3, P4 are converted respectively to images P3′, P4′ through this aligning operation.

After images P3, P4 are aligned with each other and converted to images P3′, P4′ by the aligning means 210, the subtraction image creating means 220 creates a subtraction image (subtraction image) Su2 representing the difference in density between the two images by performing the inter-image operation between images P3′ and P4′ (step S22). As for the inter-image operation, the subtractive operation that performs the subtractive operations between corresponding pixels of the images P3′ and P4′ maybe used. In addition, weighted subtractive operation, in which a weight is allocated to the difference obtained through the subtractive operation in accordance with the amount of difference and the position in the image and the like, may also be used. In this embodiment, the subtraction image Su2 is assumed to have been obtained through the subtractive operation in which the image P4′ has been subtracted from the image P3′.

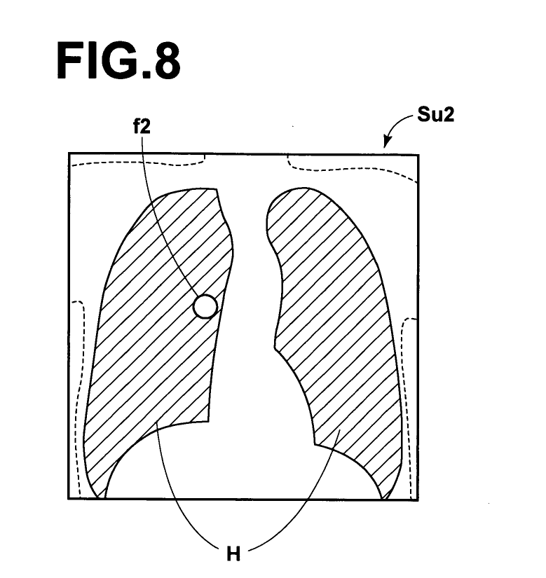

FIG. 8 shows the subtraction image Su2. In the subtraction image Su2 created in the manner described above, the anatomical noise, such as the bony part image and the like which are obstructive in identifying the abnormal pulmonary ventilation region is substantially eliminated, the artifact arising from the positional displacement due to the change in the bodily posture is suppressed, and the difference between the images P3′ and P4′ is emphasized. The abnormal pulmonary ventilation region is a region where virtually no ventilation takes place, so that it has a specific quality that it always appears in the X-ray images at the same density level regardless of whether a contrast medium (non-radioactive xenon gas) is inhaled into the lungs or not. Accordingly, in the subtraction image Su2, the abnormal pulmonary ventilation region f2 appears at a low density level (substantially in pure white) in the lung fields H indicated at the intermediate density level. This quality may be used for identifying the abnormal pulmonary ventilation region.

After the subtraction image Su2 is created by the subtraction image creating means 220, the displaying means 231 displays the subtraction image Su2 on a CRT screen or the like, the hard-copying means 232 produces the hard copy of the subtraction image Su2 on paper or film, or the transmitting means 233 transmits the subtraction image Su2 as image data to a database or other devices (not shown) connected to the image processing apparatus 200 (step S23).

Thereafter, the image examiner examines the subtraction image Su2 displayed on the screen, or recorded on paper or film to identify the abnormal pulmonary ventilation region based on the quality of the abnormal pulmonary region described above. Further, the subtraction image Su2 stored in a database or the like may be read out for diagnosis when needed.

According to the image processing apparatus 200 of the second embodiment described above, the two images to be compared are energy-subtracted soft part images with the bony part of the chest eliminated, each obtained by performing the inter-image operation between the two images obtained by recording radiations having different energy distributions with each other transmitted through the chest, so that comparison may be made between the two images with the bony part causing the anatomical noise eliminated in advance, thereby differential information (subtraction image) having less amount of anatomical noise may be obtained from the two images to be compared.

In the second preferred embodiment, the X-rays having different energy distributions may be a monochromatic X-ray having the energy corresponding to the pre-K-edge region of non-radioactive xenon gas, and that having the energy corresponding to the post-K-edge region of non-radioactive xenon gas respectively.

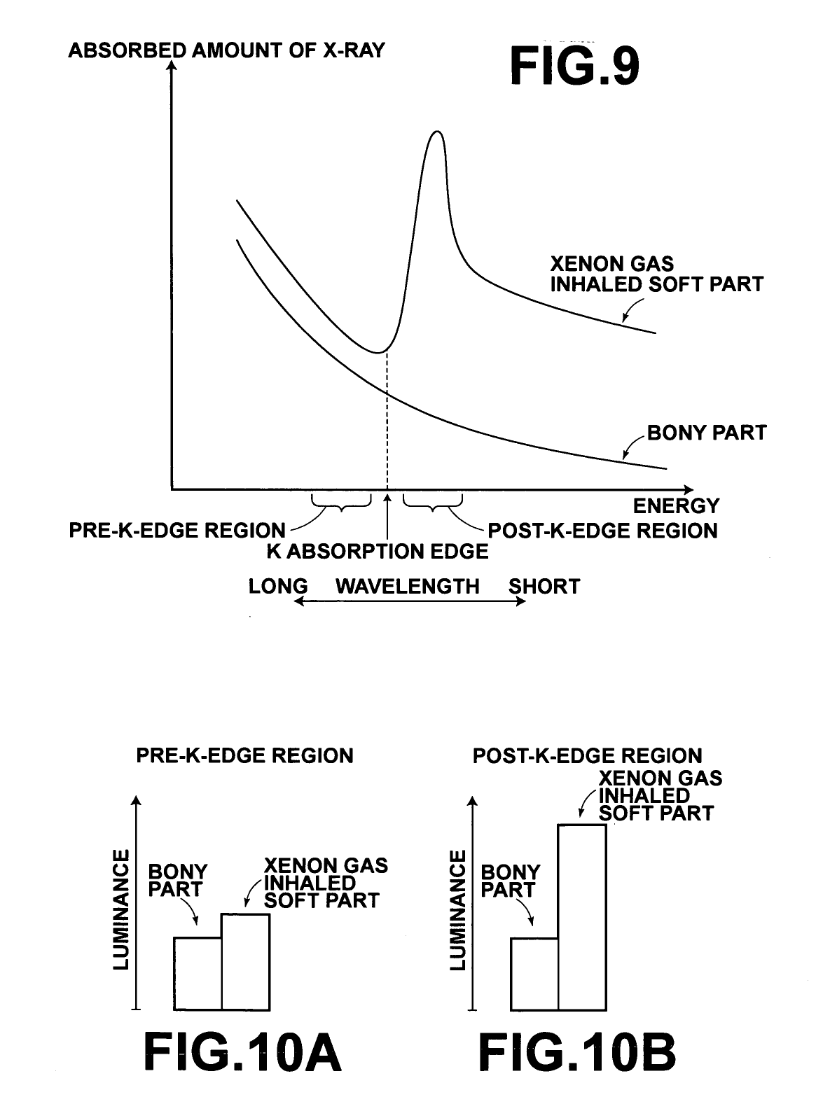

The X-ray absorption spectrum of the non-radioactive xenon gas changes greatly before and after the K absorption edge. That is, the dose of X-ray absorbed by the bony part and soft part with non-radioactive xenon gas inhaled differs with each other for specific energy (wavelength) of the X-ray. As is illustrated in FIG. 9, the amount of X-ray absorbed by the bony part does not show any significant change before and after the K-absorption edge. In contrast, the amount of X-ray absorbed by the soft part with non-radioactive xenon gas inhaled is small in the pre-K-edge region and becomes greater in the post-K-edge region.

In this connection, if one of the two basic images from which the energy-subtracted soft part image is obtained using the monochromatic X-ray having the energy corresponding to the pre-K-edge region (wavelength region where the absorption rate of X-ray drops locally on the lower energy side of the K absorption edge), and the other using the monochromatic X-ray having the energy corresponding to the post-K-edge region (wavelength region where the absorption rate of X-ray increases locally on the higher energy side of the K absorption edge) respectively, then in the image obtained using the monochromatic X-ray having the energy corresponding to the pre-K-edge region, the soft part with the non-radioactive xenon gas inhaled is caused to have a lower luminance level (higher density level) as shown in FIG. 1A, and in the image obtained using the monochromatic X-ray having the energy corresponding to the post-K-edge region, the soft part with the non-radioactive xenon gas inhaled is caused to have a higher luminance level (lower density level) as shown in FIG. 10B. Thus, the difference of the soft part with the non-radioactive xenon gas inhaled becomes greater between the two images, so that the energy-subtracted soft part image obtained from these two images becomes a high contrast image in which the soft part with the non-radioactive xenon gas inhaled is emphasized, that is, the lung fields are primarily emphasized, thereby further clarified differential information (subtraction image) may be obtained.

The image processing apparatus according to the first and second embodiments described above has a subtraction image creating means for creating a subtraction image representing the difference between an air-inhaled (energy-subtracted) image and gas-inhaled (energy-subtracted) image acting as the differential information obtaining means. In addition to this, it may also has a differential region extracting means for extracting a region having difference that satisfies a predetermined criterion between the two images and obtaining the information representing the differential region extracted. In this case, satisfying the predetermined criterion may be defined, for example, as either or both of the difference between the two images and the size of the region having the difference in density are greater than or equal to a predetermined threshold. That is, the region having a greater difference in density than a specific level, and the region having the difference in density which is greater in size than a certain size are extracted. This method allows a region having significant difference that exceeds the difference caused by the noise to be extracted as a candidate of the abnormal pulmonary ventilation region.

A program for causing a computer to act as each of the means of the image processing apparatus described above may be created and supplied by recording it on a computer readable recording medium or by storing it in a server accessible by the computer for later use by downloading. By doing so, a general-purpose computer may be used to provide the functions of the image processing apparatus described above and obtain the same effects.

1. An image processing method comprising the steps of:
aligning a first image obtained when air is inhaled into lungs and a second image obtained when a gas having a different absorption rate of radiation from that of said air is inhaled into said lungs, said first and second images being projected radiation images of the same chest obtained through radiation imaging;
obtaining differential information representing the difference between said two images by comparing said two images aligned with each other; and
outputting said differential information obtained.

2. An image processing method according to claim 1, wherein said two images are plainly imaged chest radiation images.

3. An image processing method according to claim 2, wherein said differential information is a subtraction image representing said difference between said two images.

4. An image processing method according to claim 2, wherein said differential information is the information indicating a region satisfying a predetermined criterion among the regions where said difference is observed between said two images.

5. An image processing method according to claim 4, wherein said satisfying said predetermined criterion is defined as said difference between said two images and/or the size of said region having said difference is greater than or equal to a predetermined threshold.

6. An image processing method according to claim 1, wherein said two images are energy-subtracted soft part images of said chest with the bony part image of said chest eliminated, each obtained by performing the inter-image operation between two radiation images obtained by recording radiations having different energy distributions with each other transmitted through said chest.

7. An image processing method according to claim 6, wherein said radiations having different energy distributions with each other are a monochromatic radiation having the energy corresponding to the pre-K-edge region of said gas and a monochromatic radiation having the energy corresponding to the post-K-edge region of said gas.

8. An image processing method according to claim 7, wherein said differential information is a subtraction image representing said difference between said two images.

9. An image processing method according to claim 7, wherein said differential information is the information indicating a region satisfying a predetermined criterion among the regions where said difference is observed between said two images.

10. An image processing method according to claim 9, wherein said satisfying said predetermined criterion is defined as said difference between said two images and/or the size of said region having said difference is greater than or equal to a predetermined threshold.

11. An image processing method according to claim 6, wherein said differential information is a subtraction image representing said difference between said two images.

12. An image processing method according to claim 6, wherein said differential information is the information indicating a region satisfying a predetermined criterion among the regions where said difference is observed between said two images.

13. An image processing method according to claim 12, wherein said satisfying said predetermined criterion is defined as said difference between said two images and/or the size of said region having said difference is greater than or equal to a predetermined threshold.

14. An image processing method according to claim 1, wherein said differential information is a subtraction image representing said difference between said two images.

15. An image processing method according to claim 1, wherein said differential information is the information indicating a region satisfying a predetermined criterion among the regions where said difference is observed between said two images.

16. An image processing method according to claim 15, wherein said satisfying said predetermined criterion is defined as said difference between said two images and/or the size of said region having said difference is greater than or equal to a predetermined threshold.

17. An image processing method according to claim 16, wherein said gas is non-radioactive xenon gas.

18. An image processing method according to claim 1, wherein said gas is non-radioactive xenon gas.

19. An image processing apparatus comprising:
an aligning means for aligning a first image obtained when air is inhaled into lungs and a second image obtained when a gas having a different absorption rate of radiation from that of said air is inhaled into said lungs, said first and second images being projected radiation images of the same chest obtained through radiation imaging;
a differential information obtaining means for obtaining differential information representing the difference between said two images by comparing said two images aligned with each other by said aligning means; and
an outputting means for outputting said differential information obtained by said differential information obtaining means.

20. A program for causing a computer to act as:
an aligning means for aligning a first image obtained when air is inhaled into lungs and a second image obtained when a gas having a different absorption rate of radiation from that of said air is inhaled into said lungs, said first and second images being projected radiation images of the same chest obtained through radiation imaging;
a differential information obtaining means for obtaining differential information representing the difference between said two images by comparing said two images aligned with each other by said aligning means; and
an outputting means for outputting said differential information obtained by said differential information obtaining means.
